(19) United States
(12) Patent Application Publication
(10) Pub. No.: US 2004/0139575 A1
(43) Pub. Date: Jul. 22, 2004

(54) Vehicle bumper and method of attachment

(76) Inventor: John S. Kargilis, Northville, MI (US)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 10/347,020

(22) Filed: Jan. 17, 2003

(51) Int. Cl. E05F 5/06

(52) U.S. Cl. 16/86 R

(57) ABSTRACT

A bumper for a motor vehicle surface and a method of attaching the same. The bumper includes a body and at least one tail for attaching the bumper to the motor vehicle surface. The tail is integral to the body and includes a threaded or grooved tail portion. The tail includes a threaded or grooved aperture formed therein for receiving the tail portion therethrough. The bumper attachment method includes inserting a tail of the bumper through an opening formed in the motor vehicle surface and passing the threaded or grooved portion of the tail through an aperture formed within the tail to inhibit removal of the bumper from the motor vehicle surface.

### TECHNICAL FIELD OF THE INVENTION

The present invention relates generally to vehicular bumpers. More particularly, the invention relates to a vehicle bumper and method of attachment.

### BACKGROUND OF THE INVENTION

Bumpers are attached to vehicles to protect surfaces in the event of collisions. To ensure that the bumper is able to perform this function, it is desirable to provide secure attachment to the vehicle surface. This may prevent unwanted bumper detachment from impacts, vandalism, or everyday wear-and-tear. Accordingly, numerous strategies for attaching a bumper to a vehicle surface have been developed.

One bumper attachment strategy known in the art involves using one or more fasteners, clips, or holding members. An example of such a strategy includes U.S. Pat. No. 6,233,792 to Kanie, which is incorporated by reference herein. The Kanie patent discloses a holding clip for a bumper or the like which is capable of sufficiently holding the bumper against gravity, while maintaining an easy mounting operation. Although this strategy may provide secure bumper attachment, the need for additional parts increases the cost and complexity of the manufacture process. As such it would be desirable to provide a strategy for attaching a bumper to a vehicle surface without the need for additional clips, fasteners, or holding members.

Another bumper attachment strategy known in the art involves using a single-piece holding member integral to the bumper. The holding member is typically manufactured from a resilient material and inserted through a hole formed in the vehicle surface. As the holding member is sized larger than the hole, friction forces maintain attachment of the bumper to the vehicle surface. Although this strategy provides attachment without additional clips, fasteners, or holding members, real world tests have shown that some bumpers attached by these means are prone to “easy” removal by impacts, vandalism, or everyday wear-and-tear (e.g., car washes, excessive vibrations, and the like). As such, it would be desirable to provide a strategy for attaching a bumper to a vehicle surface that is less prone to “easy” removal. Therefore, it would be desirable to provide a strategy for attaching a bumper to a vehicle surface that overcomes the aforementioned and other disadvantages.

### SUMMARY OF THE INVENTION

One aspect of the present invention provides a bumper for a motor vehicle surface. The bumper includes a body and at least one tail for attaching the bumper to the motor vehicle surface. The tail is integral to the body and includes a threaded tail portion. The tail includes a threaded aperture formed therein for receiving the threaded tail portion therethrough. The bumper may be manufactured from at least one resilient material such as plastic, rubber, acrylic, silicone, vinyl, urethane, and combinations thereof. The threaded aperture may be aligned about perpendicular to a tail axis. The tail may be in a loop configuration and the threaded tail portion may be positioned adjacent the motor vehicle surface when the bumper is attached. The tail may be tapered.

Another aspect of the invention provides a method of attaching a bumper to a motor vehicle surface. The method includes inserting a tail of the bumper through an opening formed in the motor vehicle surface and threading a portion of the tail through an aperture formed within the tail. Threading the tail portion may include looping the tail, positioning the tail portion adjacent the motor vehicle surface, and/or pinning the bumper to the motor vehicle surface.

Yet another aspect of the present invention provides a bumper for a motor vehicle surface. The bumper includes means for inserting the bumper through an opening formed in the motor vehicle surface and means for attaching the bumper to the motor vehicle surface.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 is a perspective view of a vehicle hood surface for receiving two bumpers in accordance with the present invention;

FIG. 2A is a partial cut-away view of a bumper including a tail inserted through a vehicle surface in accordance with the present invention; and

FIG. 2B is a partial cut-away view of the bumper of FIG. 2A shown with a threaded tail portion fully threaded through a threaded aperture in accordance with the present invention.

### DESCRIPTION OF THE PRESENTLY PREFERRED EMBODIMENTS

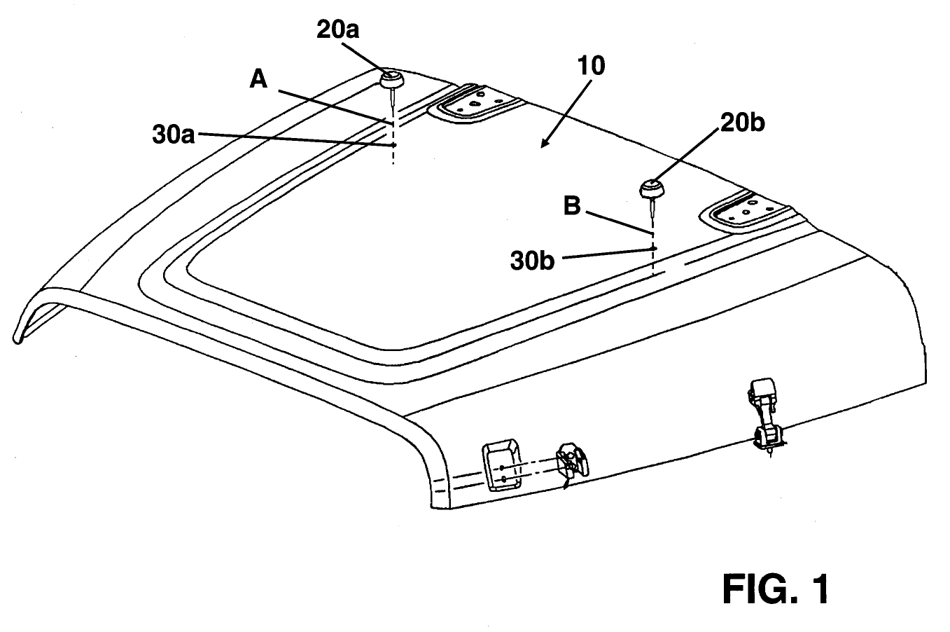

Referring to the drawings, wherein like reference numerals refer to like elements, FIG. 1 is a perspective view of a motor vehicle surface, shown generally by numeral 10, for receiving two bumpers 20a, 20b in accordance with the present invention. Bumpers 20a, 20b are shown in alignment (dashed lines A, B) with corresponding openings 30a, 30b formed in the vehicle surface 10, which in this case is a vehicle hood. Bumpers 20a, 20b are shown in a state prior to attachment to the vehicle hood surface 10.

Those skilled in the art will recognize that the bumpers 20a, 20b and vehicle surface 10 may vary. Bumpers 20a, 20b may be any number of shapes including, but not limited to, rounded, elongated, spherical, square-shaped, bar-shaped, compound shapes, and the like. Furthermore, the bumpers 20a, 20b may have various functions including, but not limited to, protecting surfaces, absorbing shock, and reducing impact from collisions. In this case, the bumpers 20a, 20b function to protect a windshield (not shown) from contact with the vehicle surface 10. Vehicle surface 10 may be any number of motor vehicle surfaces including, but not limited to, a hood, door, trunk, roof, fender, grill, dashboard, interior surface, exterior surface, and the like. Furthermore, the vehicle surface 10 may be manufactured from metal, metal alloy, plastic, or any other material capable of having a hole formed therein.

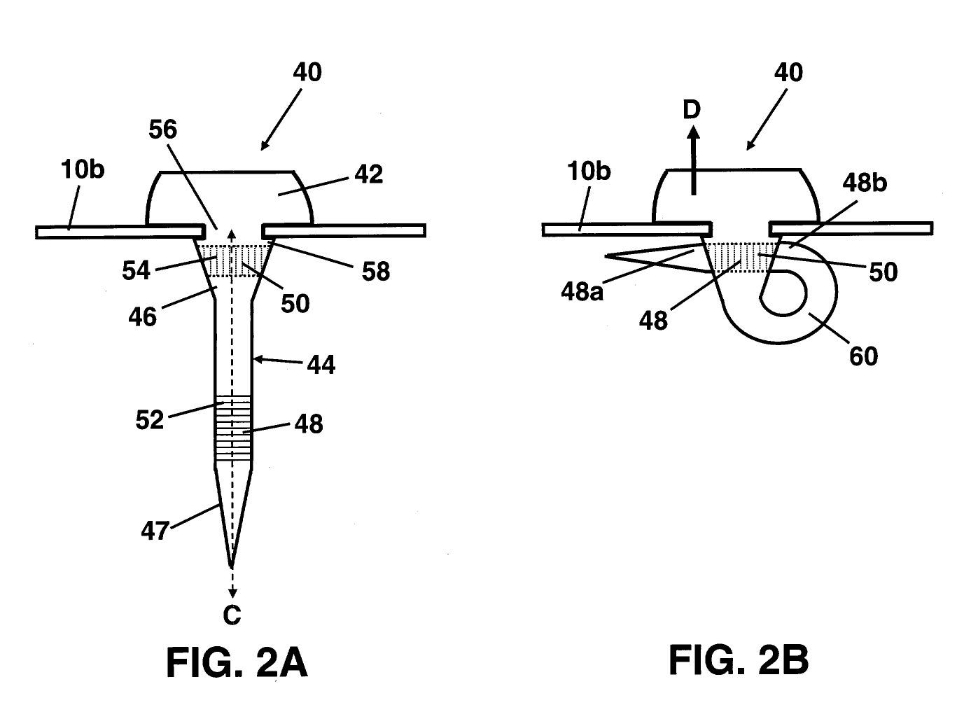

Referring now to FIG. 2A, one embodiment of a bumper 40 of the present invention is shown in partial cut-away view. Bumper 40 includes a body 42 and at least one tail 44 for attachment to a motor vehicle surface 10b. Bumper 40 may be manufactured from at least one resilient material such as plastic, rubber, acrylic, silicone, vinyl, urethane, and combinations thereof. In the illustrated and described embodiments, bumper 20a, 20b, 40 (see also FIG. 1) is manufactured from rubber. Body 42 may be a variety of shapes, as previously described, and in this case is a flattened hemisphere. It should be recognized by one skilled in the art that the body 42 may include more than one tail 44 for attachment to the vehicle surface 10b.

Tail 44 is integral to the body 42 thus forming a one-piece unit. As such, bumper 40 may be made during a single manufacture step (e.g., a simple molding process). Tail 44 may be tapered, which is defined herein as a reduced axial diameter or profile from a first tail portion 46 to a second tail portion 47. Tail 44 includes a threaded tail portion 48 and a threaded aperture 50 formed in the tail 44. The threaded aperture 50 is designed for receiving the threaded tail portion 48 therethrough.

In one embodiment, the threaded aperture 50 shape, in this case cylindrical, corresponds to the shape of the threaded tail portion 48. The threaded tail portion 48 axial diameter is slightly smaller than the threaded aperture 50 to allow threading therein. Furthermore, grooves 52 of the threaded tail portion 48 typically correspond to grooves 54 of the threaded aperture 50. The threaded aperture 50 may be aligned about perpendicular to a tail axis C.

During attachment of the bumper 40, tail 44 is inserted through an opening 56 formed in the vehicle surface 10b. Tail 44 may be inserted by pushing or pulling through the opening 56 as known in the art for attaching bumpers, and this may be achieved manually or by machine. A tail neck portion 58, which may be greater in diameter than the opening 56, may compress radially inward (i.e., normal to tail axis C) to allow passage and full insertion of the tail 44.

In FIG. 2A, the tail 44 is shown in a fully inserted state. In this state, the tail neck portion 58 may re-expand radially outward to a diameter greater than that of the opening 56. As the bumper 40 may be manufactured from a resilient material, expansion of the tail neck portion 48 occurs after insertion through the opening 56. At this point, the bumper 40 and the tail neck portion 58 diameters may both be greater than the opening 56, thus preventing bumper 40 movements in any direction. As such, the bumper 40 is fixedly retained to the vehicle surface 10b, albeit not to its fullest degree.

After the tail 44 is inserted through the opening 56, the threaded tail portion 48 is threaded through the aperture 50. To achieve this, the threaded tail portion 48 may be looped around itself and threaded manually or by machine. An adhesive may be optionally added to one or both of the grooves 52, 54 to further secure the threaded tail portion 48 within the threaded aperture 50. Alternative to mating grooves 52, 54, other means of securing the tail 44 within the aperture 50 are possible: tapered press fit, knurl pattern, dimple pattern, longitudinal grooves, etc.

In FIG. 2B, the threaded tail portion 48 is shown fully threaded through the threaded aperture 50 to form a tail loop configuration 60. The threaded tail portion 48 may be positioned adjacent the vehicle surface 10b in this state. As such, the threaded tail portion 48 and flanking portions 48a, 48b may effectively “pin” the bumper 40 and prevent it from being forcibly removed (i.e., in direction of arrow D) from the vehicle surface 10b. Tail neck portion 58 is also less susceptible to compression and removal through opening 56. At this point, the bumper 40 is fully attached to the vehicle surface 10b.

While the embodiments of the invention disclosed herein are presently considered to be preferred, various changes and modifications can be made without departing from the spirit and scope of the invention. For example, the bumper configuration and the attachment method are not limited to any particular design or sequence. Specifically, the bumper body and tail shape, size and length, tail number, material constitution, threading, and aperture position may vary without limiting the utility of the invention.

Upon reading the specification and reviewing the drawings hereof, it will become immediately obvious to those skilled in the art that myriad other embodiments of the present invention are possible, and that such embodiments are contemplated and fall within the scope of the presently claimed invention. The scope of the invention is indicated in the appended claims, and all changes that come within the meaning and range of equivalents are intended to be embraced therein.

What is claimed is:

1. A bumper for a motor vehicle surface, the bumper comprising:
a body; and
at least one tail for attaching the bumper to the motor vehicle surface, the tail integral to the body and including a threaded tail portion; wherein the tail includes a threaded aperture formed therein for receiving the threaded tail portion therethrough.

2. The bumper of claim 1 wherein the bumper is manufactured from at least one resilient material.

3. The bumper of claim 2 wherein the resilient material comprises at least one material selected from a group consisting of a plastic, rubber, acrylic, silicone, vinyl, urethane, and combinations thereof.

4. The bumper of claim 1 wherein the tail is tapered.

5. The bumper of claim 1 wherein the tail comprises a loop configuration when the bumper is attached.

6. The bumper of claim 1 wherein the threaded tail portion is positioned adjacent the motor vehicle surface when the bumper is attached.

7. The bumper of claim 1 wherein the threaded aperture is aligned about perpendicular to a tail axis.

8. A method of attaching a bumper to a motor vehicle surface, the method comprising:
inserting a tail of the bumper through an opening formed in the motor vehicle surface; and
threading a portion of the tail through an aperture formed within the tail.

9. The method of claim 8 wherein the bumper is manufactured from at least one resilient material.

10. The method of claim 9 wherein the resilient material comprises at least one material selected from a group consisting of a plastic, rubber, acrylic, silicone, vinyl, urethane, and combinations thereof.

11. The method of claim 8 wherein threading the tail portion comprises looping the tail.

12. The method of claim 8 wherein threading the tail portion comprises positioning the tail portion adjacent the motor vehicle surface.

13. The method of claim 8 wherein threading the tail portion comprises pinning the bumper to the motor vehicle surface.

14. A bumper for a motor vehicle surface, the bumper comprising:
a body;
at least one tail integral to the body and adapted to pass through an opening in a motor vehicle surface, the tail having an upper portion and a lower portion, the upper portion including an aperture passing therethrough for receiving the lower portion.

15. The bumper of claim 14, wherein the lower portion further comprises a grooved outer surface.

16. The bumper of claim 15, wherein the aperture further comprises grooves complementary to the grooved outer surface for inhibiting removal of the lower portion from the aperture.
